(19) United States
(12) Patent Application Publication
(10) Pub. No.: US 2017/0298659 A1
(43) Pub. Date: Oct. 19, 2017

(54) ONBOARD LOCKING DEVICE AND LOCKING SYSTEM

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Akiyo WATANABE, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 15/507,951

(22) PCT Filed: Sep. 2, 2015
(86) PCT No.: PCT/JP2015/074914

§ 371 Date: Mar. 1, 2017

(30) Foreign Application Priority Data
Sep. 2, 2014 (JP) 2014-178410

(51) Int. Cl. E05B 77/54; E05B 77/48; E05B 77/46

(52) U.S. Cl. CPC E05B 77/54; E05B 77/465; E05B 77/48

(57) ABSTRACT

The present invention provides an onboard locking device and locking system capable of automatically locking a vehicle door after confirming that a portable device is outside the vehicle and at least a predetermined distance away. An onboard locking device which, when a door provided to a vehicle is in a closed state, performs wireless communication with a portable device and locks the vehicle door in accordance with a result of the wireless communication. The onboard locking device includes a distance identifier identifying a distance of the portable device relative to the vehicle using wireless communication with the portable device; a determiner determining whether the distance identified by the distance identifier is at least a predetermined distance; and a locker locking the vehicle door when the determiner determines that the predetermined distance has been met or exceeded.

### FIELD OF THE INVENTION

The present invention relates to an onboard locking device and locking system locking a door of a vehicle in response to a distance of a portable device relative to the vehicle.

### BACKGROUND OF THE INVENTION

Door lock control devices having walk-away lock functionality are known (for example, Patent Literature 1). When opening or closing of a vehicle door is detected after an engine has stopped, a door lock control device wirelessly transmits, using radio waves, an ID request signal requesting an ID of a portable device in the possession of a user. The portable device receives the ID request signal transmitted from the door lock control device and transmits a response signal to the door lock control device. The door lock control device recognizes the presence of the portable device by receiving the response signal transmitted from the portable device. In a case where the response signal is not returned from the portable device after at least a certain amount of time, despite the ID request signal being transmitted periodically, the door lock control device provides a lock instruction signal to an electronic door lock device and the vehicle doors automatically lock.

### RELATED ART

### Patent Literature

Patent Literature 1: Japanese Patent Laid-open Publication No. H10-292702

### SUMMARY OF THE INVENTION

### Problems to be Solved by the Invention

However, in the door lock control device according to Patent Literature 1, in a case with an unfavorable wireless communication environment, the door lock control device may fail to receive the response signal and automatically lock the vehicle doors despite the user, who carries the portable device, being in a vicinity of the vehicle. In some cases, the vehicle doors may be locked even when the portable device is inside the vehicle.

The instant application provides an onboard locking device and locking system capable of automatically locking vehicle doors after confirming that a portable device is outside a vehicle and that the portable device is at least a predetermined distance away.

### Means for Solving the Problems

An onboard locking device according to one aspect of the present invention is an onboard locking device which, when a door provided to a vehicle is in a closed state, performs wireless communication with a portable device and locks the door in accordance with a result of the wireless communication. The onboard locking device includes a distance identifier identifying a distance of the portable device relative to the vehicle using wireless communication with the portable device; a determiner determining whether the distance identified by the distance identifier is at least a predetermined distance; and a locker locking the door when the determiner determines that the identified distance is at least the predetermined distance.

An onboard locking device according to another aspect of the present invention is an onboard locking device which, when the door provided to the vehicle is in the closed state, performs wireless communication with the portable device and locks the door in accordance with the result of the wireless communication. The onboard locking device includes the distance identifier identifying the distance of the portable device relative to the vehicle using wireless communication with the portable device; the determiner determining whether the distance identified by the distance identifier is at least the predetermined distance; and a vehicle interior/exterior determiner determining whether the portable device is inside the vehicle using wireless communication with the portable device when the determiner determines that the portable device is at less than the predetermined distance. When the vehicle interior/exterior determiner determines that the portable device is not inside the vehicle, the distance identifier is configured to once again identify the distance of the portable device relative to the vehicle. The onboard locking device further includes the locker locking the door when the distance, identified by the distance identifier after the vehicle interior/exterior determiner determines that the portable device is not inside the vehicle, is at least the predetermined distance, or when identification of the distance by the distance identifier fails.

A locking system according to another aspect of the present invention includes the onboard locking device according to any one of the above aspects, and a portable device performing wireless communication with the onboard locking device.

The present application can be achieved not only as an onboard locking device which includes such characteristic processors, but can also be achieved as a locking control method performing the aforesaid characteristic processes in steps, as a program executing the aforesaid steps on a computer, and the like. In addition, the present application can be achieved as a semiconductor integrated circuit accomplishing all or a portion of an onboard locking mechanism, as some other system that includes an onboard locking device or locking system, or the like.

### Effect of the Invention

According to the above description, an onboard locking device and locking system can be provided which are capable of automatically locking vehicle doors after confirming that a portable device is outside a vehicle and that the portable device is at least a predetermined distance away.

### BRIEF DESCRIPTION OF THE DRAWINGS

FIG. 1 is a schematic view illustrating an exemplary configuration of a locking system.

FIG. 2 is a block diagram illustrating an exemplary configuration of an onboard device.

FIG. 3 is a block diagram illustrating an exemplary configuration of a portable device.

FIG. 4 is a flow chart illustrating a processing protocol of an onboard controller associated with a locking process.

FIG. 5 is an explanatory diagram illustrating a conceptual example of a predetermined distance range.

FIG. 6 is a flow chart illustrating a processing protocol of a subroutine associated with a distance identification.

FIG. 7 is a timing chart illustrating signals sent and received by a process of the distance identification.

FIG. 8 is a flow chart illustrating a processing protocol of a subroutine associated with a warning process.

FIG. 9 is a flow chart illustrating a processing protocol of a subroutine associated with a first locking process.

FIG. 10 is a flow chart illustrating a processing protocol of a subroutine associated with a second locking process.

FIG. 11 is a flow chart illustrating a processing protocol of a subroutine associated with a modified distance identification.

### MODE FOR CARRYING OUT THE INVENTION

### Description of Embodiments of the Present Invention

First, a description is provided of several embodiments of the present invention. Also, at least a portion of the embodiments listed below may be used in combination as desired.

(1) An onboard locking device according to one aspect of the present invention is an onboard locking device which, when a door provided to a vehicle is in a closed state, performs wireless communication with a portable device and locks the door in accordance with a result of the wireless communication. The onboard locking device includes a distance identifier identifying a distance of the portable device relative to the vehicle using wireless communication with the portable device; a determiner determining whether the distance identified by the distance identifier is at least a predetermined distance; and a locker locking the door when the determiner determines that the predetermined distance has been met or exceeded.

In the present application, the onboard locking device identifies the distance of the portable device relative to the vehicle using wireless communication with the portable device. Then, in a case where the distance of the portable device relative to the vehicle is determined to be at least the predetermined distance, the onboard locking device locks the door of the vehicle. In this configuration, the vehicle door is locked after the distance of the portable device relative to the vehicle has been confirmed. Therefore, when a user holding the portable device is away from the vehicle, the door is locked. Specifically, in a state where a location of the portable device relative to the vehicle is uncertain, the vehicle door will not be locked. In a case where there is a failure to identify the distance of the portable device relative to the vehicle, generally the onboard locking device does not lock the door of the vehicle. Even when there is a failure to identify the distance, the portable device may be present in a vicinity of the vehicle, so automatically locking the door of the vehicle when the location of the portable device is uncertain may cause difficulties.

(2) A configuration is preferred in which a vehicle interior/exterior determiner is provided determining whether the portable device is inside the vehicle using wireless communication with the portable device; and, when the distance of a first portable device relative to the vehicle is determined by the determiner to be at least the predetermined distance, and a second portable device is determined by the vehicle interior/exterior determiner to not be inside the vehicle, the locker locks the door.

In the present application, the onboard locking device identifies whether the portable device is inside the vehicle using wireless communication. In a case where the distance of the portable device relative to the vehicle is at least the predetermined distance and the portable device is not inside the vehicle, the onboard locking device locks the door. Accordingly, a situation where the door of the vehicle is automatically locked and where the portable device is shut inside the vehicle can be reliably prevented.

(3) An onboard locking device according to another aspect of the present invention is an onboard locking device which, when the door provided to the vehicle is in the closed state, performs wireless communication with the portable device and locks the door in accordance with the result of the wireless communication. The onboard locking device includes the distance identifier identifying the distance of the portable device relative to the vehicle using wireless communication with the portable device; the determiner determining whether the distance identified by the distance identifier is at least the predetermined distance; and the vehicle interior/exterior determiner determining whether the portable device is inside the vehicle using wireless communication with the portable device when the determiner determines that the portable device is at less than the predetermined distance. When the vehicle interior/exterior determiner determines that the portable device is not inside the vehicle, the distance identifier is configured to once again identify the distance of the portable device relative to the vehicle. The onboard locking device further includes the locker locking the door when the distance, identified by the distance identifier after the vehicle interior/exterior determiner determines that the portable device is not inside the vehicle, meets or exceeds the predetermined distance, or when identification of the distance by the distance identifier fails.

In the present application, the onboard locking device identifies the distance of the portable device relative to the vehicle using wireless communication with the portable device. Then, in a case where the distance of the portable device relative to the vehicle is determined to be less than the predetermined distance, the onboard locking device determines whether the portable device is inside the vehicle using wireless communication. When the distance of the portable device relative to the vehicle is less than the predetermined distance, it is presumed that the user is not in situations where the door is locked promptly, and a certain amount of time is required for the portable device to move at least the predetermined distance away from the vehicle. Therefore, the onboard locking device executes a process confirming whether the portable device is inside the vehicle prior to rechecking the distance of the portable device. When the portable device is determined to not be in the vehicle, the onboard locking device once again identifies the distance of the portable device relative to the vehicle. After confirming that the portable device is not in the vehicle, when the distance of the portable device relative to the vehicle is determined to be at least the predetermined distance, the onboard locking device locks the door of the vehicle. Also, when the identification of the distance of the portable device relative to the vehicle fails after confirming that the portable device is not in the vehicle, the portable device has presumably moved outside a wireless communication range of the onboard locking device, and therefore the onboard locking device locks the door of the vehicle. In this way, aspect (3) has a configuration which first confirms that the portable device is not inside the vehicle at a stage where the portable device has not moved at least the predetermined distance away from the vehicle. Therefore, when the portable device is identified as being at least the predetermined distance away from the vehicle, the door can be locked promptly. Also, the onboard locking device according to aspect (3) achieves advantageous effects similar to those of aspect (1).

(4) A configuration is preferred in which, when the distance, identified by the distance identifier after the vehicle interior/exterior determiner has determined that the portable device is not inside the vehicle, is less than the predetermined distance, the distance identifier repeatedly identifies the distance of the portable device relative to the vehicle, and the locker locks the door when a distance less than the predetermined distance is repeatedly identified.

In the present application, the onboard locking device repeatedly identifies the distance of the portable device relative to the vehicle when the distance of the portable device relative to the vehicle is less than the predetermined distance. Then, when the portable device continues to be in a region less than the predetermined distance from the vehicle for a certain period of time, the onboard locking device locks the door of the vehicle. In a case where there is little potential that the user may return to the interior of the vehicle, the door of the vehicle can automatically lock for safety reasons.

(5) Preferably, when the distance of the portable device, identified by the distance identifier after at least a predetermined period of time has elapsed following the vehicle interior/exterior determiner determining that the portable device is not inside the vehicle, is less than the predetermined distance, the locker locks the door.

In the present application, the onboard locking device begins tracking an amount of time elapsed when the distance of the portable device relative to the vehicle is less than the predetermined distance. Then, when the portable device continues to be in a region less than the predetermined distance from the vehicle for at least the predetermined period of time, the onboard locking device locks the door of the vehicle. In a case where there is little potential that the user may return to the interior of the vehicle, the door of the vehicle can automatically lock for safety reasons.

(6) Preferably, a configuration includes a warner which, in a case where the distance identifier fails to identify the distance, provides a warning notification when the vehicle interior/exterior determiner determines that the portable device is not inside the vehicle.

In the present application, the onboard locking device emits the warning notification when identification of the distance of the portable device relative to the vehicle fails. In a case where there is a failure to identify the distance of the portable device relative to the vehicle, generally the onboard locking device does not lock the door of the vehicle. Even when there is a failure to identify the distance, the portable device may be present in a vicinity of the vehicle, so automatically locking the door of the vehicle when the location of the portable device is uncertain may cause difficulties. Therefore, the onboard locking device can emit the warning notification and rely on the user to lock the door.

(7) Preferably, a configuration includes a motor operation detector detecting an operation status of a motor mounted in the vehicle, and an open/closed detector detecting an open/closed status of the door. Preferably, the distance identifier initiates identification of the distance of the portable device when the motor is stopped and the door has transitioned from an open state to a closed state.

In the present application, when the motor is stopped and the door of the vehicle has transitioned from the open state to the closed state, there is a high potential for a situation where the user has exited the vehicle and is departing. Therefore, the processes of aspects (1) to (6), described above, are executed.

(8) A locking system according to another aspect of the present invention includes the onboard locking device according to any one of the embodiments noted above, and a portable device performing wireless communication with the onboard locking device.

The present application achieves advantageous effects similar to those of aspects (1) to (7).

(9) Preferably, the onboard locking device includes an onboard transmitter transmitting, from an antenna provided to the vehicle, a detection signal used to detect the portable device. Preferably, the portable device includes a portable receiver receiving the detection signal transmitted from the onboard transmitter, a detector detecting reception signal strength of the detection signal received by the portable receiver, and a portable transmitter transmitting a response signal which contains information on the reception signal strength detected by the detector. Preferably, the onboard locking device includes an onboard receiver receiving the response signal transmitted from the portable device, and the distance identifier calculates the distance of the portable device relative to the vehicle based on the reception signal strength contained in the response signal received by the onboard receiver.

In the present application, the portable device detects the reception signal strength of the detection signal transmitted from the antenna provided to the vehicle and transmits the response signal, which includes the detected reception signal strength, to the onboard locking device. The reception signal strength of the detection signal detected by the portable device changes depending on the distance of the portable device relative to the vehicle. Accordingly, the distance can be identified using the reception signal strength of the detection signal. The onboard locking device receives the response signal transmitted from the portable device and identifies the distance of the portable device relative to the vehicle using the reception signal strength contained in the received response signal.

(10) Preferably, the onboard locking device includes the onboard transmitter transmitting, from the antenna provided to the vehicle, the detection signal used to detect the portable device. Preferably, the portable device includes the portable receiver receiving the detection signal transmitted from the onboard transmitter, the detector detecting the reception signal strength of the detection signal received by the portable receiver, a distance calculator calculating the distance of the portable device relative to the vehicle based on the reception signal strength detected by the detector, and the portable transmitter transmitting the response signal which contains information on the distance calculated by the distance calculator. Preferably, the onboard locking device includes the onboard receiver receiving the response signal transmitted from the portable device, and the distance identifier identifies the distance of the portable device relative to the vehicle based on the information contained in the response signal received by the onboard receiver.

In the present application, the portable device detects the reception signal strength of the detection signal transmitted from the antenna provided to the vehicle. The reception signal strength of the detection signal detected by the portable device changes depending on the distance of the portable device relative to the vehicle. Accordingly, the distance of the portable device relative to the vehicle can be identified using the reception signal strength of the detection signal. Based on the detected reception signal strength, the portable device identifies the distance of the portable device relative to the vehicle and transmits the response signal, which contains information on the identified distance, to the onboard locking device. The onboard locking device receives the response signal and identifies the location of the portable device relative to the vehicle based on the information included in the received response signal. In the identification of the distance of the portable device, performed by the onboard locking device, the onboard locking device does not necessarily need to perform all processes based on the reception signal strength. Instead, a portion of the distance identification process may be performed on the portable device side.

### Detailed Description of Embodiment of the Present Invention

Specific examples of an onboard locking device and locking system according to an embodiment of the present invention are described hereafter with reference to the drawings. The present invention is not limited to these examples and is indicated by the scope of the claims. Construals equivalent to the scope of the claims and all modifications within the scope of the claims are included.

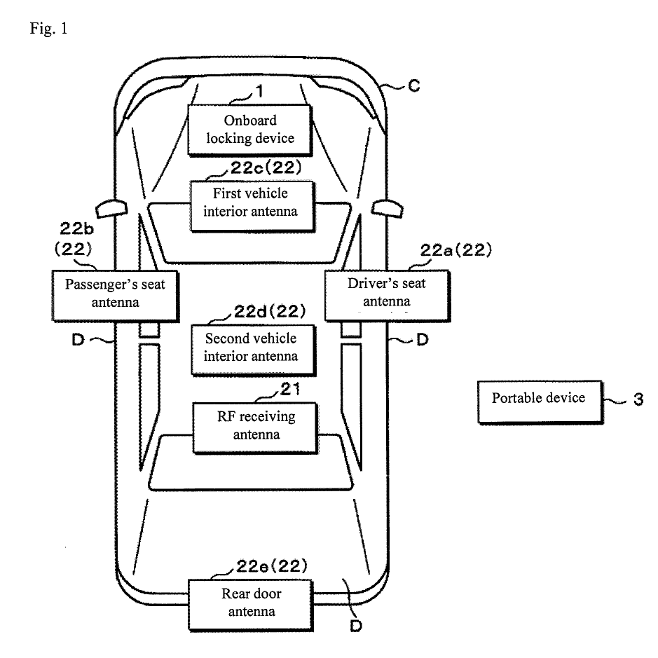

FIG. 1 is a schematic view illustrating an exemplary configuration of a locking system. The locking system according to the present embodiment includes an onboard locking device 1 sending and receiving various signals using a plurality of LF transmitting antennae 22 and an RF receiving antenna 21, which are provided to the vehicle C; and one or a plurality of portable devices 3 sending the signals to and receiving the signals from the onboard locking device 1. The onboard locking device 1 identifies the distance of the portable device 3 relative to the vehicle C and executes a locking process for a vehicle door D or executes a warning process. The plurality of LF transmitting antennae 22 include, for example, a driver's seat antenna 22a, a passenger's seat antenna 22b, a first vehicle interior antenna 22c, a second vehicle interior antenna 22d, a rear door antenna 22e, and the like, and each LF transmitting antenna 22 transmits a signal using LF band radio waves. The LF band is an exemplary radio wave band on which the signals are transmitted, and the radio wave band is not necessarily limited to this. The driver's seat antenna 22a and the passenger's seat antenna 22b are arranged, respectively, on a driver's seat-side pillar and a passenger's seat-side pillar. The first vehicle interior antenna 22c is provided to a front portion of the vehicle C, and the second vehicle interior antenna 22d is arranged in a central portion of the vehicle C. The rear door antenna 22e is arranged at a rear door of the vehicle C. In this example, the driver's seat antenna 22a, the passenger's seat antenna 22b, and the rear door antenna 22c transmit various signals to the portable device 3, which is primarily outside the vehicle, and thereby detect the location of the portable device 3 outside the vehicle. The driver's seat antenna 22a, the passenger's seat antenna 22b, and the rear door antenna 22c each transmit various signals primarily to a region outside the vehicle in the vicinity of each antenna. More specifically, the driver's seat antenna 22a, the passenger's seat antenna 22b, and the rear door antenna 22c function as vehicle exterior antennae transmitting a process initiation signal to the portable device 3, which is primarily outside the vehicle. The detection signal used to detect the location of the portable device 3 is configured to be transmitted from essentially all of the LF transmitting antennae 22. Even when detecting the location of the portable device 3 inside the vehicle, the driver's seat antenna 22a, the passenger's seat antenna 22b, and the rear door antenna 22c function as antennae transmitting the detection signal to the portable device 3. Meanwhile, the first vehicle interior antenna 22c and the second vehicle interior antenna 22d transmit various signals to the portable device 3, which is primarily inside the vehicle, and thereby detect the location of the portable device 3 inside the vehicle. The first vehicle interior antenna 22c and the second vehicle interior antenna 22d each transmit various signals primarily to a region inside the vehicle in the vicinity of each antenna. More specifically, the first vehicle interior antenna 22c and the second vehicle interior antenna 22d function as vehicle interior antennae transmitting the process initiation signal to the portable device 3, which is primarily inside the vehicle, the signal initiating a process to detect the location of the portable device 3. The detection signal used to detect the location of the portable device 3 is configured to be transmitted from essentially all of the LF transmitting antennae 22. Even when detecting the location of the portable device 3 outside the vehicle, the first vehicle interior antenna 22c and the second vehicle interior antenna 22d function as antennae transmitting the detection signal to the portable device 3. The two vehicle interior antennae (i.e., the first vehicle interior antenna 22c and the second vehicle interior antenna 22d) are provided because the entire vehicle interior cannot be covered by a single LF transmitting antenna 22. Specifically, the portable device 3 cannot receive the various signals transmitted from a single LF transmitting antenna 22 over the entire range of the vehicle interior. In the following description, an example is provided in which a location detection signal is transmitted from all of the LF transmitting antennae 22. However, depending on circumstances, the present invention does not exclude a configuration in which a detection signal is transmitted from a portion of the plurality of LF transmitting antennae 22.

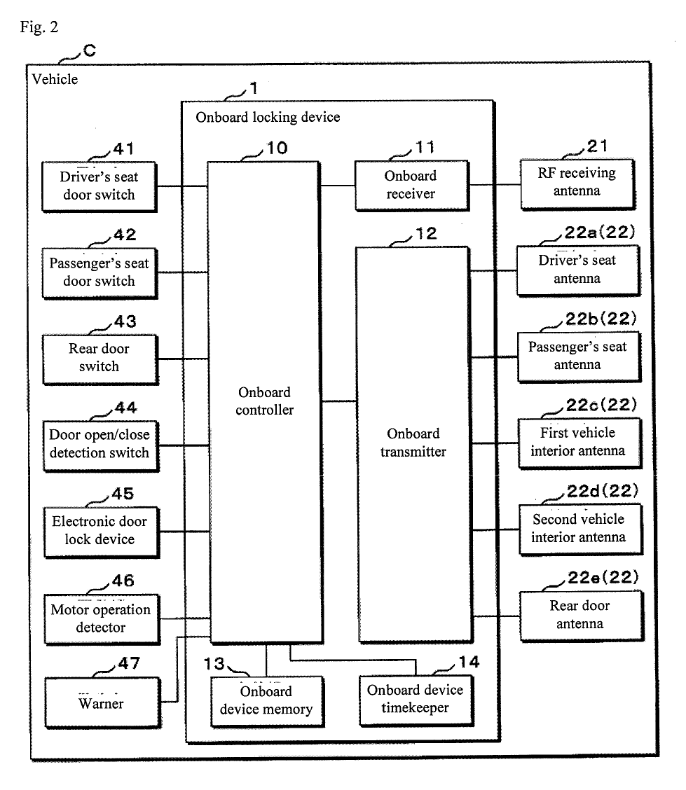

FIG. 2 is a block diagram illustrating an exemplary configuration of the onboard locking device 1. The onboard locking device 1 includes an onboard controller 10 controlling operations of various components of the onboard locking device 1. The onboard controller 10 is, for example, a microcomputer having one or a plurality of CPUs (Central Processing Units), a multicore CPU, or the like. The onboard controller 10 includes an onboard receiver 11, an onboard transmitter 12, an onboard device memory 13, and an onboard device timekeeper 14.

By executing a control program (described below) stored in the onboard device memory 13, the onboard controller 10 controls operations of various components, identifies the distance of the portable device 3 relative to the vehicle C, and executes a predetermined process in response to distance identification results.

The onboard device memory 13 is a non-volatile memory such as EEPROM (Electrically Erasable Programmable ROM), flash memory, or the like. The onboard device memory 13 stores the control program which, through the onboard controller 10 controlling the operations of various components of the onboard locking device 1, identifies the distance of the portable device 3 relative to the vehicle C and performs the locking process for the vehicle door D or performs the warning process.

The onboard receiver 11 is connected to the RF receiving antenna 21, receives various signals (such as the response signal) transmitted from the portable device 3 using UHF band radio waves, and outputs the received signals to the onboard controller 10. It is possible to communicate over a wide area using UHF band radio waves, and therefore the placement of the RF receiving antenna 21 in the vehicle C is not particularly limited.

The onboard transmitter 12 is connected to the plurality of LF transmitting antennae 22 and, in accordance with control by the onboard controller 10, transmits the detection signal determining whether the portable device 3 is inside or outside the vehicle C. Strength of the detection signals transmitted from each of the LF transmitting antennae 22 is defined such that the portable device 3, which is either inside or outside the vehicle C, can receive the detection signal from at least two LF transmitting antennae 22.

The onboard device timekeeper 14 initiates timekeeping in accordance with control by the onboard controller 10 and sends a timekeeping result to the onboard controller 10. The onboard device timekeeper 14 may, for example, be used in a process of tracking an amount of time that the portable device 3 is inside a predetermined distance range, as described below.

The onboard controller 10 is connected to a driver's seat door switch 41, a passenger's seat door switch 42, a rear door switch 43, and the like, and a door signal corresponding to an operation status of each door switch is input to the onboard controller 10. In the following, any of the driver's seat door switch 41, the passenger's seat door switch 42, and the rear door switch 43 may be referred to as a door switch, as appropriate. Based on the door signal from each door switch, the onboard controller 10 can recognize the operation status of the driver's seat door switch 41, the passenger's seat door switch 42, and the rear door switch 43. The driver's seat door switch 41 and the passenger's seat door switch 42 are switches locking or unlocking the vehicle doors D on the driver's seat side or the passenger's seat side, respectively, and are provided to a door handle on the driver's seat side or passenger's seat side, respectively. The rear door switch 43 is a switch locking or unlocking the rear door, which is one of the vehicle doors D, and is provided to an exterior of the rear door. Each door switch is a push button. A touch sensor detecting the user touching the door handle may be provided instead of the push button. Also, the onboard controller 10 may instead obtain the door signal corresponding to operation of each door switch directly, or may obtain the door signal via a door ECU (Electronic Control Unit), some other ECU, or the like.

In addition, the onboard controller 10 is connected to a door open/closed detection switch 44 detecting whether each of the vehicle doors D is open or closed. The door open/closed detection switch 44 is a switch that turns on and off according to whether the vehicle doors D are open or closed, and the switch 44 is configured so as to input to the onboard controller 10 an open/closed signal corresponding to the on/off status.

Moreover, an electronic door lock device 45, a motor operation detector 46, and a warner 47 are connected to the onboard controller 10. The electronic door lock device 45 includes a locking mechanism that locks and unlocks each of the vehicle doors D, and an actuator driving the locking mechanism. The electronic door lock device 45 drives the actuator in accordance with control by the onboard controller 10 and locks and unlocks the vehicle doors D. The motor operation detector 46 is, for example, an ignition switch, and is configured so as to input to the onboard controller 10 a signal corresponding to an operation position of the ignition switch. Using the signal corresponding to the operation position of the ignition switch, the onboard controller 10 can recognize whether a motor is operating. When the motor is operating in the present application, this includes a state where the motor is temporarily stopped due to an idling stop function. Alternatively, when the vehicle C is equipped with a smart start system, a configuration is also possible in which a signal associated with the operation status of the motor due to operation of a smart start button may be received from a body ECU or the like (not shown in the drawings) and the operation status of the motor is recognized. The warner 47 is a light emitter or device having a speaker, horn, or the like that emits audio, capable of issuing a warning notification to the user. The light emitter may be a vehicle interior light, auxiliary light outside the vehicle, a light provided to a side mirror, or the like. By controlling operation of the warner 47, the onboard controller 10 can provide the user with a warning notification regarding locking the vehicle doors D using a light or sound.

FIG. 2 depicts the driver's seat door switch 41, the passenger's seat door switch 42, the rear door switch 43, the door open/closed detection switch 44, the electronic door lock device 45, the motor operation detector 46, and the warner 47 as directly connected to the onboard controller 10. However, the various switches and the warner 47 may instead be directly connected by a signal wire, or may be connected via an onboard communications network such as CAN or LIN, or may be connected via some other ECU.

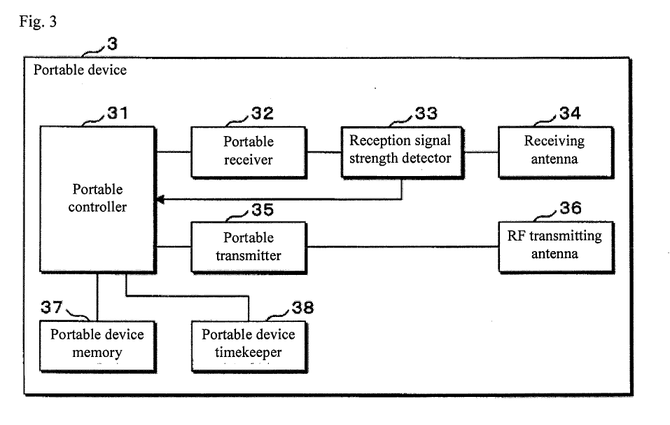

FIG. 3 is a block diagram illustrating an exemplary configuration of the portable device 3. The portable device 3 includes a portable controller 31 controlling operations of various components of the portable device 3. The portable controller 31 is, for example, a microcomputer having one or a plurality of CPUs, a multicore CPU, or the like. The portable controller 31 includes a portable receiver 32, a portable transmitter 35, a portable device memory 37, and a portable device timekeeper 38.

By reading a control program (described below) stored in the portable device memory 37 and controlling operations of various components, the portable controller 31 executes a process transmitting, to the onboard locking device 1, information necessary to control operations of various components and identify the distance of the portable device 3 relative to the vehicle C.

The portable device memory 37 is a non-volatile memory similar to the onboard device memory 13. The portable device memory 37 stores a control program which executes a process transmitting, to the onboard locking device 1, the response signal or the like which contains information to identify the distance of the portable device 3 relative to the vehicle C through the portable controller 31 controlling the operations of various components of the portable locking device 3.

The portable receiver 32 is connected to the receiving antenna 34 via a reception signal strength detector 33, receives various signals transmitted from the onboard locking device 1 using LF band radio waves, and outputs the received signal to the portable controller 31. The receiving antenna 34 is, for example, a three axis antenna, and is capable of obtaining a specific reception signal strength regardless of an orientation or posture of the portable device 3 relative to the vehicle C.

The reception signal strength detector 33 is a circuit detecting the reception signal strength of the detection signal received by the receiving antenna 34 and outputting the detected reception signal strength to the portable controller 31.

The portable transmitter 35 is connected to an RF transmitting antenna 36 and, in accordance with control by the portable controller 31, transmits the response signal corresponding to the detection signal transmitted from the onboard locking device 1. The portable transmitter 35 transmits the response signal using UHF band radio waves. The UHF band is an exemplary radio wave band on which the signals are transmitted, and the radio wave band is not necessarily limited to this.

The portable device timekeeper 38 initiates timekeeping in accordance with control by the portable controller 31 and sends a timekeeping result to the portable controller 31. The timekeeper measures a timing at which the response signal is transmitted.

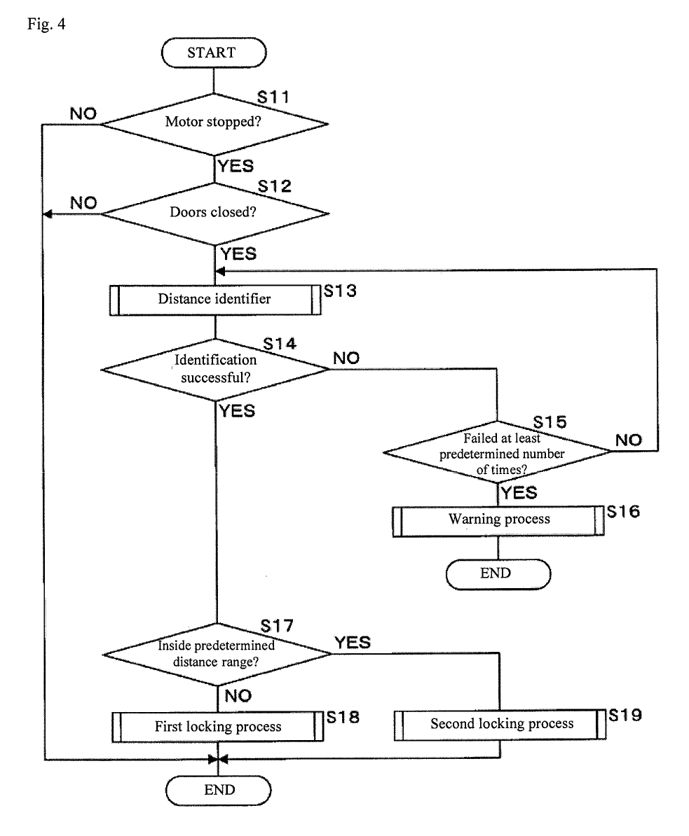

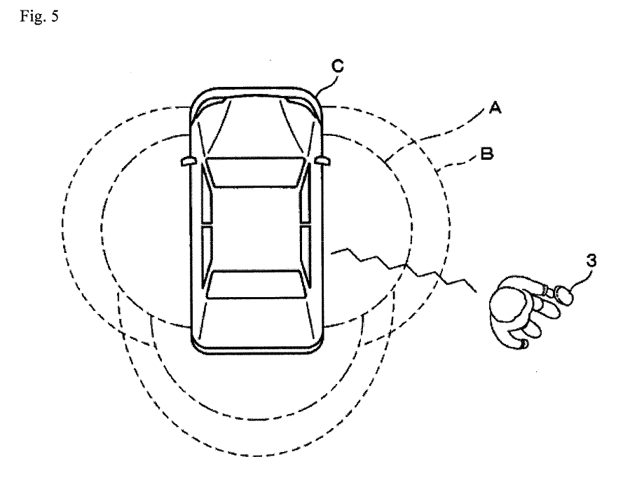

FIG. 4 is a flow chart illustrating a processing protocol of the onboard controller 10 associated with a locking process. FIG. 5 is an explanatory diagram illustrating a conceptual example of the predetermined distance range. In FIG. 5, semicircles indicated by a two dot dashed line A indicate a position of the predetermined distance centered on an exterior surface of the vehicle C, and centered on, in particular, the passenger's seat antenna 22b, the driver's seat antenna 22a, and the rear door antenna 22e, respectively. The predetermined distance is, for example, two meters. Hereafter, a region inside the semicircles indicated by the two dot dashed line A is referred to as inside the predetermined distance range, and a region outside the semicircles is referred to as outside the predetermined distance range. Outside semicircles indicated by a dashed line B indicate a region outside the wireless communication area (i.e., a region where wireless communication between the onboard locking device 1 and the portable device 3 is not possible). The range where wireless communication between the onboard locking device 1 and the portable device 3 can occur is not particularly limited. A configuration is also possible in which wireless communication can occur in a range of 2.5 m centered on each antenna, for example. Ideally, a state is preferred where wireless communication can occur in a range of 10 m centered on the vehicle C. As described below, the onboard controller 10 executes a process automatically locking the vehicle doors D or various warning processes depending on whether the location of the portable device 3 relative to the vehicle is inside the predetermined distance range, whether the location is outside the predetermined distance range, or whether the location is outside the wireless communication area.

The onboard controller 10 detects an operation status of the motor using the motor operation detector 46 and determines whether the motor is stopped (step S11). In the case of a vehicle C having an idling stop function, when the motor is temporarily stopped due to the idling stop function, the motor is determined to be in operation. When a determination is made that the motor is not stopped (step S11: NO), the onboard controller 10 ends the process.

When a determination is made that the motor is stopped (step S11: YES), the onboard controller 10 detects the open/closed status of the vehicle doors D using the door open/closed detection switch 44, the vehicle doors D transition from the open state to the closed state, and a determination is made as to whether all of the vehicle doors D are in the closed state (step S12). For example, when the vehicle doors D are in the open state, the open/closed signal is at a high level and when the vehicle doors D are in the closed state, the open/closed signal is at a low level. In such a case, the onboard controller 10 may determine that the vehicle doors D have transitioned from the open state to the closed state when the open/closed signal changes from the high level to the low level. Alternatively, when the open/closed signals corresponding to each of the vehicle doors D are all at a low level, a determination may be made that all of the vehicle doors D are in the closed state. When there is determined to be no change such that the vehicle doors D have transitioned from the open state to the closed state and all of the vehicle doors D are closed (step S12: NO), the onboard controller 10 ends the process.

When a determination is made that the vehicle doors D have transitioned from the open state to the closed state and all of the vehicle doors D are closed (step S12: YES), the onboard controller 10 identifies the distance of the portable device 3 relative to the vehicle C using wireless communication with the portable device 3 (step S13). While executing the process shown in FIG. 4, the onboard controller 10 monitors the vehicle doors D opening and start-up of the motor. In a case where opening of the vehicle doors D is detected, when the high level open/closed signal is input to the onboard controller 10 as an interrupt signal, for example, the onboard controller 10 is configured to interrupt the process being executed and return the process to step S12. This is because when the vehicle doors D have opened, the automatic locking process and the warning process are unnecessary. In addition, in a case where start-up of the motor is detected, when the signal corresponding to operation of the ignition switch, which starts up the motor, is input to the onboard controller 10, for example, the onboard controller 10 interrupts the process being executed. This is because when the motor is operating, the automatic locking process and the warning process are unnecessary.

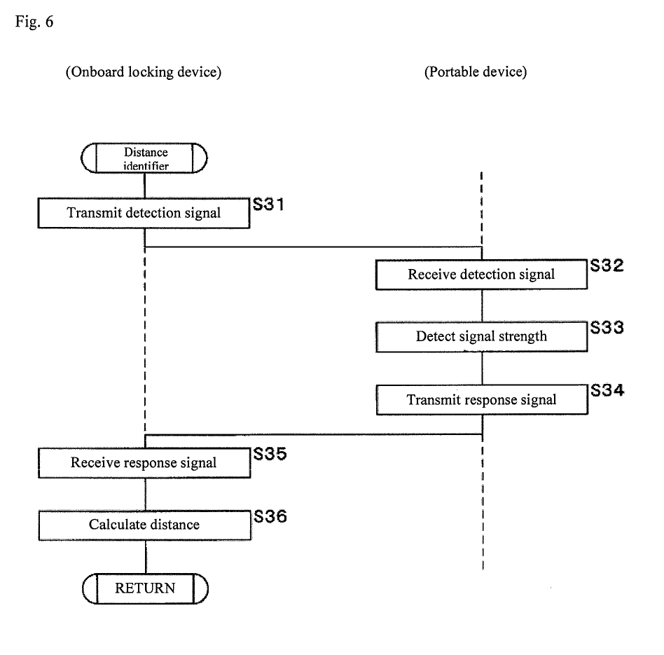

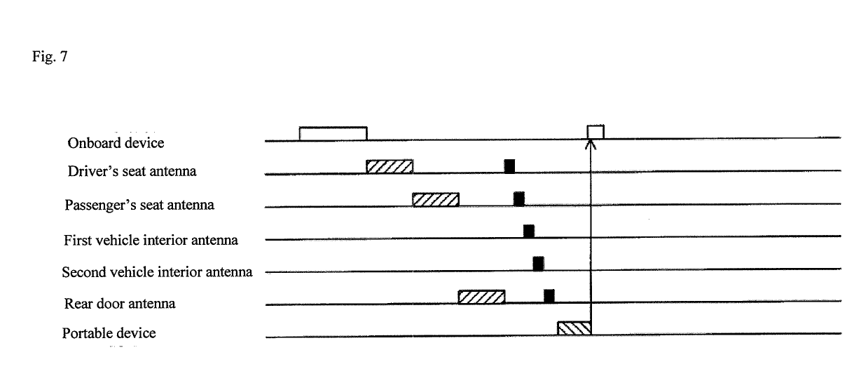

FIG. 6 is a flow chart illustrating a processing protocol of a subroutine associated with the distance identification. FIG. 7 is a timing chart illustrating signals sent and received by a process of the distance identification. In FIG. 7, the “onboard device” is a timing chart illustrating a process execution status of the onboard controller 10, which is provided to the onboard locking device 1. Whited-out rectangular portions indicate a time span where the onboard controller 10 is executing some process. In FIG. 7, the “driver's seat antenna 22a,” “passenger's seat antenna 22b,” “first vehicle interior antenna 22c,” “second vehicle interior antenna 22d,” and “rear door antenna 22e” are timing charts illustrating the timing at which a signal is transmitted from the various LF transmitting antennae 22. Rectangular portions having hatching descending diagonally leftward indicate the timing at which a process initiation signal is transmitted from the driver's seat antenna 22a, the passenger's seat antenna 22b, the first vehicle interior antenna 22c, the second vehicle interior antenna 22d, or the rear door antenna 22e. The process initiation signal is a signal initiating a process detecting the distance of the portable device 3 relative to the vehicle C. Finally, blacked-out rectangles indicate the timing at which the detection signal identifying the distance of the portable device 3 is transmitted.

In FIG. 7, the “portable device” is a timing chart indicating the timing at which the portable device 3 transmits the response signal. A rectangular portion having hatching descending diagonally rightward indicates the response signal transmitted from the portable device 3. In the example shown in FIG. 7, the portable device 3 is present and the response signal is transmitted from the portable device 3. The response signal is a signal that contains information for detecting the location of the portable device 3.

By providing a control signal to the onboard transmitter 12, the onboard controller 10 causes the detection signal to be transmitted from the plurality of LF transmitting antennae 22 (step S31). More specifically, before transmission of the detection signal, the onboard controller 10 causes the process initiation signal to be transmitted from the plurality of LF transmitting antennae 22, the signal starting up the portable device 3 and initiating the process. For example, as shown in FIG. 7, the process initiation signals (rectangular portions having hatching descending diagonally leftward) are sent successively from the driver's seat antenna 22a, the passenger's seat antenna 22b, and the rear door antenna 22e at a different timing for each LF transmitting antenna 22. There may be a plurality of portable devices 3 inside the vehicle C or in the vicinity of the vehicle C; however, the process initiation signal is a signal capable of being jointly received by the plurality of portable devices 3. The portable device 3 receiving the process initiation signals transmitted from the onboard locking device 1 starts up from a sleep state. Without waiting for a response from the portable device 3, the onboard controller 10 transmitting the process initiation signal causes the detection signal (blacked-out rectangles) to be successively transmitted from the plurality of LF transmitting antennae 22 at a different timing for each LF transmitting antenna 22.

The present embodiment is also characterized by the LF transmitting antenna 22 which last transmits the process initiation signal (in this example, the rear door antenna 22e) transmitting the detection signal last. Transmitting the detection signal from one LF transmitting antenna 22 immediately after the process initiation signal is transmitted from the same LF transmitting antenna 22 places a burden on the LF transmitting antenna 22. However, by providing a configuration such that, when the process initiation signal is transmitted from a first LF transmitting antenna 22, the detection signal is transmitted from a second LF transmitting antenna 22 and, finally, the detection signal is transmitted from the first LF transmitting antenna 22, it is possible to avoid concentrating the burden of signal transmission in one LF transmitting antenna 22. In the present invention, an order of the plurality of LF transmitting antennae 22 which transmit the detection signals is not particularly limited to the order described above. Any desired order can be established.

Furthermore, the distance identification method described above is exemplary. A configuration is also possible such that the distance of the portable device 3 relative to the vehicle C is identified simply based on the reception signal strength of the detection signal from a single transmitting antenna.

The portable controller 31 receives, with the portable receiver 32 and via the receiving antenna 34, the detection signal transmitted from the LF transmitting antennae 22 (step S32). Then, the portable controller 31 detects the reception signal strength of the received detection signal (step S33). Next, as shown in FIG. 7, the portable controller 31 transmits, to the onboard locking device 1, a response signal (rectangular portion descending diagonally rightward) containing the reception signal strength of the detection signal transmitted from each of the LF transmitting antennae 22 (step S34).

The onboard controller 10 receives, with the onboard receiver 11, the response signal transmitted from the portable device 3 (step S35). Then, the onboard controller 10 calculates the distance of the portable device 3 relative to the vehicle C based on the reception signal strength contained in the received response signal (step S36), and the process ends. The reception signal strength at the portable device 3 for the detection signal transmitted from the LF transmitting antenna 22 corresponds to the distance between the LF transmitting antenna 22 and the portable device 3. Accordingly, the location of the portable device 3 relative to the vehicle C as well as the distance of the portable device 3 relative to the vehicle C can be calculated based on the reception signal strength of each detection signal transmitted from each of the plurality of LF transmitting antennae 22.

With reference back to FIG. 4, the onboard controller 10 which ended the process in step S13 determines whether the identification of the distance of the portable device 3 relative to the vehicle C was successful (step S14). When the distance identification is determined to have failed (step S14: NO), the onboard controller 10 determines whether the distance identification has failed at least a predetermined number of times (step S15). The predetermined number of times is not particularly limited, but is between two and three times. Regardless of whether the portable device 3 is in the vicinity of the vehicle C, the distance identification may fail for any number of reasons. Therefore, the process of step S15 is provided so as to attempt the distance identification a plurality of times and, when the distance identification has failed at least the predetermined number of times, to process this as the portable device 3 not being in the vicinity of the vehicle C.

When a determination is made that the number of failures is less than the predetermined number (step S15: NO), the onboard controller 10 returns the process to step S13 and repeatedly performs the identification of the distance of the portable device 3 relative to the vehicle C. When the distance identification is determined to have failed at least the predetermined number of times (step S15: YES), the onboard controller 10 executes a process associated with the warning notification (step S16) and ends the process.

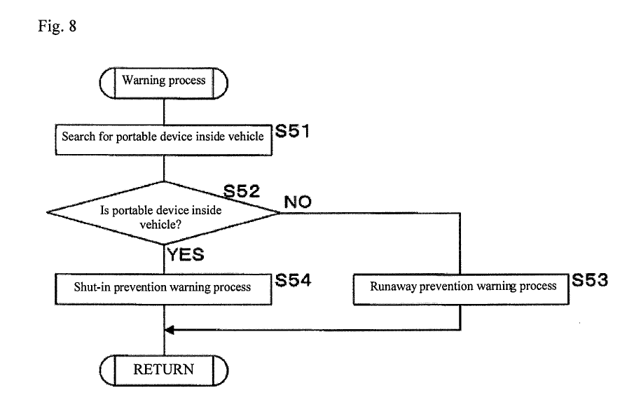

FIG. 8 is a flow chart illustrating a processing protocol of a subroutine associated with the warning process. By providing a control signal to the onboard transmitter 12, the onboard controller 10 causes the detection signal to be transmitted from the plurality of LF transmitting antennae 22, and by receiving, with the onboard receiver 11, the response signal transmitted from the portable device 3, the onboard controller 10 searches for the portable device 3 inside the vehicle (step S51). For example, the onboard controller 10 transmits the process initiation signal from the first vehicle interior antenna 22c and the second vehicle interior antenna 22d, and transmits the detection signal from each of the LF transmitting antennae 22. The onboard controller 10 receives the response signal transmitted from the portable device 3 in response to the detection signal and, based on the received response signal, determines whether the portable device 3 is inside or outside the vehicle. A configuration is also possible such that a determination is made as to whether the portable device 3 is inside the vehicle simply based on whether there is a response to the signals transmitted from the first vehicle interior antenna 22c and the second vehicle interior antenna 22d.

Next, the onboard controller 10 determines whether the portable device 3 is inside the vehicle (step S52). The search for the portable device 3 inside the vehicle may fail for any number of reasons and a misdetermination may be made that the portable device 3 is not inside the vehicle. Therefore, a configuration is also possible such that when the search for the portable device 3 inside the vehicle has failed at least the predetermined number of times, a determination is made that the portable device 3 is not inside the vehicle. The predetermined number of times is not particularly limited, but is between two and three times. This is also the case in the processes of steps S72 and S92, described below. When the portable device 3 is determined to not be inside the vehicle (step S52: NO), the onboard controller 10 executes a “runaway” warning process (step S53) and ends the process. Specifically, because the user may potentially move away from the vehicle C without locking the vehicle doors D, the onboard controller 10 controls the operation of the warner 47 and emits a warning notification to the user that the vehicle C is not locked. The warner 47 may, for example, emit the warning notification by illuminating a light or using a horn. In this example, the vehicle doors D are not locked.

When the portable device 3 is determined to be inside the vehicle in step 52 (step S52: YES), the onboard controller 10 executes a “shut-in prevention” warning process (step S54) and ends the process. Specifically, because the portable device 3 may potentially be left inside the vehicle, the onboard controller 10 controls the operation of the warner 47 and emits the portable device 3 shut-in prevention warning notification to the user. The warner 47 may, for example, emit the warning notification by illuminating a light or using a horn. In this example, the vehicle doors D are not locked.

Returning to FIG. 4, when a determination is made in step S14 that the distance identification has succeeded (step S14: YES), the onboard controller 10 determines whether the portable device 3 is inside the predetermined distance range shown in FIG. 5 (step S17). For example, the onboard locking device 10 determines whether the distance of the portable device 3 relative to the vehicle C is less than the predetermined distance.

When the portable device 3 is determined to be outside the predetermined distance range (step S17: NO), the onboard controller 10 executes a first locking process (step S18) and ends the process. When the portable device 3 is determined to be inside the predetermined distance range (step S17: YES), the onboard controller 10 executes a second locking process (step S19) and ends the process.

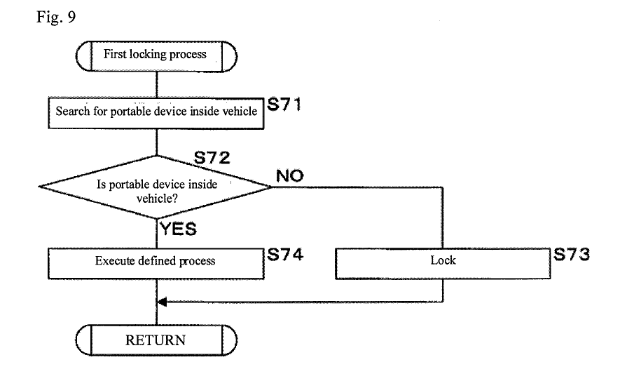

FIG. 9 is a flow chart illustrating a processing protocol of a subroutine associated with the first locking process. By providing a control signal to the onboard transmitter 12, the onboard controller 10 causes the detection signal to be transmitted from the plurality of LF transmitting antennae 22, and by receiving, with the onboard receiver 11, the response signal transmitted from the portable device 3, the onboard controller 10 searches for the portable device 3 inside the vehicle (step S71).

Next, the onboard controller 10 determines whether the portable device 3 is inside the vehicle (step S72). When the portable device 3 is determined to not be inside the vehicle (step S72: NO), the onboard controller 10 locks the vehicle doors D by outputting, to the electronic door lock device 45, a locking instruction signal giving an instruction to lock the vehicle doors D (step S73) and ends the process.

When the portable device 3 is determined to be inside the vehicle in step S72 (step S72: YES), the onboard controller 10 executes a process established by the user (step S74) and ends the process. The user can define ahead of time the nature of the process executed in step S74. In a case where one portable device 3 is outside the predetermined distance range outside the vehicle and another portable device 3 is inside the vehicle, a situation can be imagined in which the user holding the first portable device 3 has simply exited the vehicle and a passenger holding the second portable device 3 is inside the vehicle. Therefore, the user may find a warning notification unpleasant. Given this, the process may be defined so as to end in step S74 without executing processes of any special steps. Also, depending on the settings made by the user, the process may be configured to execute only the warning notification with the warner 47, or to lock the vehicle doors D.

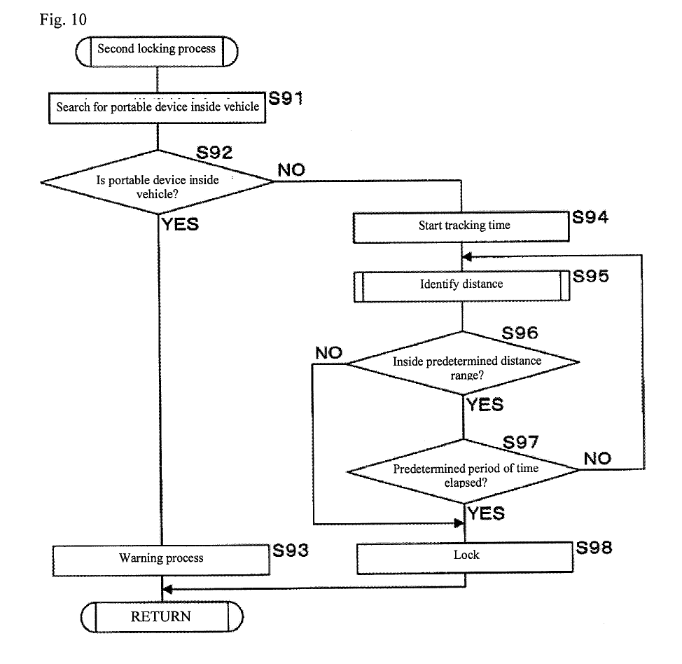

FIG. 10 is a flow chart illustrating a processing protocol of a subroutine according to the second locking process. By providing a control signal to the onboard transmitter 12, the onboard controller 10 causes the detection signal to be transmitted from the plurality of LF transmitting antennae 22, and by receiving, with the onboard receiver 11, the response signal transmitted from the portable device 3, the onboard controller 10 searches for the portable device 3 inside the vehicle (step S91).

Next, the onboard controller 10 determines whether the portable device 3 is inside the vehicle (step S92). When the portable device 3 is determined to be inside the vehicle (step S92: YES), the onboard controller 10 executes a predetermined warning process with the warner 47 (step S93) and ends the process.

When the portable device 3 is determined to not be inside the vehicle (step S92: NO), the onboard controller 10 begins tracking time with the onboard device timekeeper 14 (step S94). Then, the onboard controller 10 identifies the distance of the portable device 3 relative to the vehicle C using wireless communication with the portable device 3 (step S95) and determines whether the portable device 3 is inside the predetermined distance range (step S96). When the portable device 3 is determined to be inside the predetermined distance range (step S96: YES), the onboard controller 10 determines whether the predetermined period of time has elapsed since the onboard device timekeeper 14 began tracking time (step S97). The predetermined period of time is not particularly limited, but may be a duration of about 30 seconds, for example. When a determination is made that the predetermined period of time has not elapsed (step S97: NO), the onboard controller 10 returns the process to step S95 and repeatedly performs the identification of the distance of the portable device 3 relative to the vehicle C. The periodicity of the distance identification in steps S95 to S97 is not particularly limited. Distance identification may, for example, be executed at a period of 400 milliseconds.

When the portable device 3 is determined to be outside the predetermined distance range in step S96, or when the identification of the distance of the portable device 3 relative to the vehicle C fails (step S96: NO), or when the predetermined period of time is determined in step S97 to have elapsed (step S97: YES), the onboard controller 10 locks the vehicle doors D by outputting, to the electronic door lock device 45, the locking instruction signal giving an instruction to lock the vehicle doors D (step S98) and ends the process.

In the locking system and onboard locking device 1 according to the present embodiment having this configuration, the onboard locking device 1 can automatically lock the vehicle doors D once the onboard locking device 1 confirms that the portable device 3 is outside the vehicle and outside the predetermined distance range using the processes of steps S13, S17, and S73. Specifically, the vehicle doors D can be reliably prevented from locking in a state where the location of the portable device 3 is uncertain, and in a case where the user holding the portable device 3 has moved outside the predetermined range, the vehicle doors D can be locked automatically.

In addition, using the process of step S72 or S92, the onboard locking device 1 is configured to lock the vehicle doors D once the portable device 3 is confirmed to not be inside the vehicle. Therefore, the vehicle doors D can be locked automatically and a situation where the portable device 3 is locked inside the vehicle can be reliably prevented.

Moreover, the onboard locking device 1 can automatically lock the vehicle doors D in a case where the portable device 3 moves from within the predetermined distance range to outside the predetermined distance range, using the processes of steps S13, S17, and S94 to S98. Also, at a stage where the portable device 3 is inside the predetermined distance range, the onboard locking device 1 has a configuration which first confirms that the portable device 3 is not inside the vehicle. Therefore, when the portable device 3 moves away from the vehicle C and outside the predetermined distance range, the vehicle doors D can be locked promptly.

Moreover, using the processes of steps S94 to S98, when the portable device 3 continues to be inside the predetermined distance range for at least a predetermined period of time, because the user is unlikely to get back inside the vehicle, the onboard locking device 1 can automatically lock the vehicle doors D for safety reasons.

Furthermore, using the processes of steps S13 to S16, when identification of the distance of the portable device 3 relative to the vehicle C fails, the onboard locking device 1 can emit a warning notification and rely on the user to lock the vehicle doors D. Even when there is a failure to identify the distance of the portable device 3 relative to the vehicle C, the portable device 3 may be present in the vicinity of the vehicle C, so automatically locking the doors D of the vehicle C when the location of the portable device 3 is uncertain may cause difficulties. Therefore, the onboard controller 10 does not execute the locking process.

Still further, when the motor is stopped and the doors D of the vehicle C have transitioned from the open state to the closed state, there is a high potential for a situation where the user has exited the vehicle C and departed. Therefore, the onboard locking device 1 can appropriately execute the locking process for the vehicle doors D and the various warning processes.

Also, the onboard locking device 1 can better identify the distance of the portable device 3 relative to the vehicle C based on the reception signal strength on the portable device 3 of the detection signals from the plurality of LF transmitting antennae 22 provided to the vehicle C. Therefore, the distance can be more accurately identified as compared with a case simply using the reception signal strength of the detection signal from one LF transmitting antenna 22.

### Modification 1

In step S18 in the embodiment described above, an example is described where the vehicle doors D are locked once the portable device 3 is confirmed to not be inside the vehicle. However, a configuration is also possible such that, in a case where the portable device 3 is determined to be outside the predetermined distance range in the process of step S17, the vehicle doors D are locked without making a determination as to whether the portable device 3 is inside the vehicle.

### Modification 2

In the process of steps S94 to S97 in the embodiment described above, a configuration is described where the vehicle doors D are locked when the distance of the portable device 3 relative to the vehicle C is less than the predetermined distance for at least a predetermined amount of time. However, a configuration is also possible such that, in a case where the distance of the portable device 3, which is inside the predetermined distance range, is identified a predetermined number of times (in other words, in a case where the portable device 3 is repeatedly determined a predetermined number of times to be inside the predetermined distance range), the vehicle doors D are locked without tracking the elapsed time. In such a case, the onboard device timekeeper 14 and the timekeeper process are unnecessary.

### Modification 3

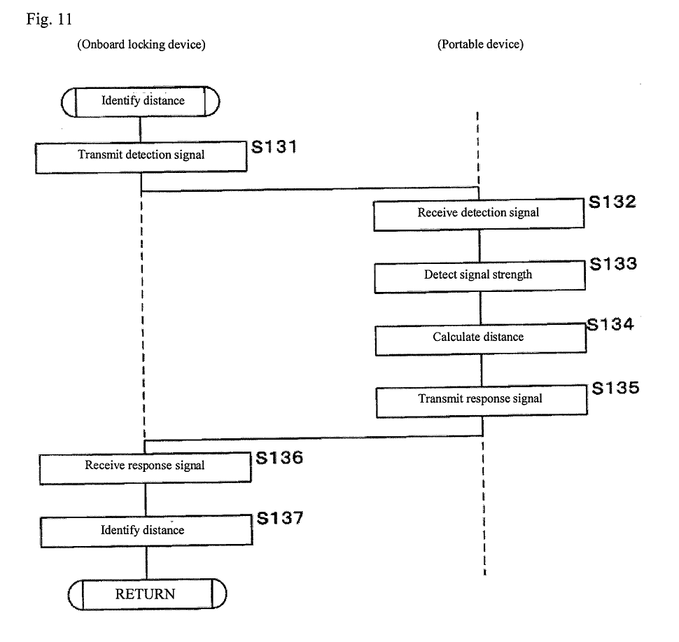

In the embodiment described above, an example is described where primarily the onboard locking device 1 identifies the distance of the portable device 3 relative to the vehicle C. However, a configuration is also possible such that the distance is calculated on the portable device 3 side. FIG. 11 is a flow chart illustrating a processing protocol of a subroutine associated with the distance identification of Modification 3. Configurations and the nature of processes other than processes associated with distance identification are similar to those of the above-noted embodiment, and therefore a detailed description thereof is omitted. By providing a control signal to the onboard transmitter 12, the onboard controller 10 causes the detection signal to be transmitted from the plurality of LF transmitting antennae 22 (step S131).

The portable controller 31 receives, with the portable receiver 32 and via the receiving antenna 34, the detection signal transmitted from the LF transmitting antennae 22 (step S132). Then, the portable controller 31 detects the reception signal strength of the received detection signal (step S133). Next, the portable controller 31 calculates the distance of the portable device 3 relative to the vehicle C based on the reception signal strength (step S134). Then, the portable controller 31 transmits, to the onboard locking device 1, the response signal containing information for the distance calculated in step S134 (step S135).

The onboard controller 10 receives, with the onboard receiver 11, the response signal transmitted from the portable device 3 (step S136). Then, the onboard controller 10 identifies the distance of the portable device 3 relative to the vehicle C based on the information contained in the received response signal (step S137), and the process ends.

The locking system and onboard locking device 1 according to modification 3 achieve advantageous effects similar to those of embodiment 1.

### REFERENCE NUMERALS

1 Onboard locking device
3 Portable device
10 Onboard controller
11 Onboard receiver
12 Onboard transmitter
13 Onboard device memory
14 Onboard device timekeeper
21 RF receiving antenna
22 LF transmitting antenna
22a Driver's seat antenna
22b Passenger's seat antenna
22c First vehicle interior antenna
22d Second vehicle interior antenna
22e Rear door antenna
31 Portable controller
32 Portable receiver
33 Reception signal strength detector
34 Receiving antenna
35 Portable transmitter
36 RF transmitting antenna
37 Portable device memory
38 Portable device timekeeper
41 Driver's seat door switch
42 Passenger's seat door switch
43 Rear door switch
44 Door open/closed detection switch
45 Electronic door locking device
46 Motor operation detector
47 Warner
C Vehicle
D Vehicle door

1. An onboard locking device which, when a vehicle door is in a closed condition, performs wireless communication with a portable device and locks the door in accordance with a result of the wireless communication, the onboard locking device comprising:
a distance identifier configured to identify a distance of the portable device relative to the vehicle using wireless communication with the portable device;
a determiner configured to determine whether the distance identified by the distance identifier is at least a predetermined distance; and
a locker configured to lock the door when the determiner determines that the identified distance is at least the predetermined distance.

2. The onboard locking device according to claim 1 comprising:
a vehicle interior/exterior determiner configured to determine whether the portable device is inside the vehicle using wireless communication with the portable device,
wherein the locker locks the door when the distance of a first portable device relative to the vehicle is determined by the determiner to be at least the predetermined distance, and a second portable device is determined by the vehicle interior/exterior determiner to not be inside the vehicle.

3. An onboard locking device which, when a vehicle door is in a closed condition, performs wireless communication with a portable device and locks the door in accordance with a result of the wireless communication, the onboard locking device comprising:
a distance identifier configured to identify a distance of the portable device relative to the vehicle using wireless communication with the portable device;
a determiner configured to determine whether the distance identified by the distance identifier is at least a predetermined distance; and
a vehicle interior/exterior determiner configured to determine whether the portable device is inside the vehicle using wireless communication with the portable device when the determiner determines that the distance is less than the predetermined distance,
wherein, when the vehicle interior/exterior determiner determines that the portable device is not inside the vehicle, the distance identifier is configured to once again identify the distance of the portable device relative to the vehicle, and
the onboard locking device further comprises a locker configured to lock the door when the distance, identified by the distance identifier after the vehicle interior/exterior determiner determines that the portable device is not inside the vehicle, is at least the predetermined distance, or when identification of the distance by the distance identifier fails.

4. The onboard locking device according to claim 3, wherein, when the distance, identified by the distance identifier after the vehicle interior/exterior determiner has determined that the portable device is not inside the vehicle, is less than the predetermined distance, the distance identifier repeatedly identifies the distance of the portable device relative to the vehicle, and
the locker locks the door when a distance less than the predetermined distance is repeatedly identified.

5. The onboard locking device according to claim 3, wherein the locker locks the door when the distance of the portable device, identified by the distance identifier after at least a predetermined period of time has elapsed following the vehicle interior/exterior determiner determining that the portable device is not inside the vehicle, is less than the predetermined distance.

6. The onboard locking device according to claim 2 further comprising:
a warner which, in a case where the distance identifier fails to identify the distance, provides a warning notification when the vehicle interior/exterior determiner determines that the portable device is not inside the vehicle.

7. The onboard locking device according to claim 1 further comprising:
a motor operation detector configured to detect an operation status of a motor mounted in the vehicle; and
an open/closed detector configured to detect an open/closed status of the door,
wherein the distance identifier initiates identification of the distance of the portable device when the motor is stopped and the door has transitioned from an open condition to a closed condition.

8. A locking system comprising:
the onboard locking device according to claim 1; and
a portable device performing wireless communication with the onboard locking device.

9. The onboard locking device according to claim 3 further comprising:
a warner which, in a case where the distance identifier fails to identify the distance, provides a warning notification when the vehicle interior/exterior determiner determines that the portable device is not inside the vehicle.

10. The onboard locking device according to claim 3 further comprising:
a motor operation detector configured to detect an operation status of a motor mounted in the vehicle; and
an open/closed detector configured to detect an open/closed status of the door,
wherein the distance identifier initiates identification of the distance of the portable device when the motor is stopped and the door has transitioned from an open condition to a closed condition.

11. A locking system comprising:
the onboard locking device according to claim 3; and
a portable device performing wireless communication with the onboard locking device.

12. A method for locking a vehicle door with an onboard locking device which performs wireless communication with a portable device and locks the door in accordance with a result of the wireless communication, the method comprising:
identifying a distance of the portable device relative to the vehicle using wireless communication with the portable device;
determining whether the distance identified is at least a predetermined distance; and
locking the door when it is determined that the identified distance is at least the predetermined distance.

13. A method for locking a vehicle door with an onboard locking device which performs wireless communication with a portable device and locks the door in accordance with a result of the wireless communication, the method comprising:
identifying a distance of the portable device relative to the vehicle using wireless communication with the portable device;
determining whether the distance identified is at least a predetermined distance;
determining whether the portable device is inside the vehicle using wireless communication with the portable device when it is determined that the identified distance is less than the predetermined distance,
wherein, when it is determined that the portable device is not inside the vehicle, again identifying a distance of the portable device relative to the vehicle and determining whether the distance identified is at least a predetermined distance; and
locking the door when it is determined that the portable device is not inside the vehicle and that either the identified distance is at least the predetermined distance or when identifying the distance fails.

14. An onboard locking device which performs wireless communication with a portable device and locks a vehicle door in accordance with a result of the wireless communication, comprising:
a lock device operable to lock and unlock the door;
a transmitter;
a receiver;
a processor and a memory storing instructions that, when executed by the processor, cause the processor to perform operations including:
identifying a distance of the portable device relative to the vehicle using wireless communication with the portable device;
determining whether the distance identified is at least a predetermined distance; and
locking the door when it is determined that the identified distance is at least the predetermined distance.

15. An onboard locking device which performs wireless communication with a portable device and locks a vehicle door in accordance with a result of the wireless communication, comprising:
a lock device operable to lock and unlock the door;
a transmitter;
a receiver;
a processor and a memory storing instructions that, when executed by the processor, cause the processor to perform operations including:
identifying a distance of the portable device relative to the vehicle using wireless communication with the portable device;
determining whether the distance identified is at least a predetermined distance;
determining whether the portable device is inside the vehicle using wireless communication with the portable device when it is determined that the identified distance is less than the predetermined distance,
wherein, when it is determined that the portable device is not inside the vehicle, again identifying a distance of the portable device relative to the vehicle and determining whether the distance identified is at least a predetermined distance; and
locking the door when it is determined that the portable device is not inside the vehicle and that either the identified distance is at least the predetermined distance or when identifying the distance fails.

16. A tangible computer-readable storage medium encoded with an executable computer program for enabling an onboard locking device to perform wireless communication with a portable device and lock a vehicle door in accordance with a result of the wireless communication, and that, when executed by a processor, causes the processor to perform operations comprising:
identifying a distance of the portable device relative to the vehicle using wireless communication with the portable device;
determining whether the distance identified is at least a predetermined distance; and
locking the door when it is determined that the identified distance is at least the predetermined distance.

17. A tangible computer-readable storage medium encoded with an executable computer program for enabling an onboard locking device to perform wireless communication with a portable device and lock a vehicle door in accordance with a result of the wireless communication, and that, when executed by a processor, causes the processor to perform operations comprising:
identifying a distance of the portable device relative to the vehicle using wireless communication with the portable device;
determining whether the distance identified is at least a predetermined distance;
determining whether the portable device is inside the vehicle using wireless communication with the portable device when it is determined that the identified distance is less than the predetermined distance,
wherein, when it is determined that the portable device is not inside the vehicle, again identifying a distance of the portable device relative to the vehicle and determining whether the distance identified is at least a predetermined distance; and
locking the door when it is determined that the portable device is not inside the vehicle and that either the identified distance is at least the predetermined distance or when identifying the distance fails.
